(19) United States
(12) Patent Application Publication
(10) Pub. No.: US 2012/0047656 A1
(43) Pub. Date: Mar. 1, 2012

(54) Head Support

(75) Inventors: Dale Alan Benton, Acworth, GA (US); Andrew Joseph Thomson, Birmingham, AL (US)

(73) Assignee: HEADS UP GROUP, INC., Acworth, GA (US)

(21) Appl. No.: 13/215,264

(22) Filed: Aug. 23, 2011

Related U.S. Application Data
(60) Provisional application No. 61/376,561, filed on Aug. 24, 2010.

(51) Int. Cl. B68G 5/00

(52) U.S. Cl. 5/640

(57) ABSTRACT

Disclosed is a support for comfortably holding a head. The support includes a platform, a chest base, and a biasing element biasing the platform against the chest base. A user places the support between his or her chin and chest to provide comfortable support to the user's head.

### CROSS-REFERENCE TO RELATED APPLICATIONS

This application claims the benefit of U.S. Provisional Application 61/376,561 filed on Aug. 24, 2010, which is hereby incorporated herein in its entirety by reference.

### FIELD

This disclosure relates to head supports. Particularly, this disclosure relates to a head support for resting.

### BACKGROUND

Frequent travelers understand the discomfort of long trips. Because of limited space on airlines, human comfort often goes unattended. Safety requirements often put automobile travelers in a front-facing position, regardless of the comfort of sitting as such. Although a pillow can sometimes be used to prop a person's head from the side, a sufficient support for the pillow is rarely found. Many airlines and automobiles do not have readily-accessible places to position a pillow or to rest against. Additionally, in other applications, the need to support a person's head comfortably has gone unaddressed.

### SUMMARY

Disclosed is a head support including a platform, a chest base, and a biasing element biasing the platform against the chest base.

### DESCRIPTION OF THE FIGURES

The features and components of the following figures are illustrated to emphasize the general principles of the present disclosure and are not necessarily drawn to scale. Corresponding features and components throughout the figures may be designated by matching reference characters for the sake of consistency and clarity.

FIG. 1 is a perspective view of a head support in accord with one embodiment of the current disclosure.

FIG. 2 is an exploded view of the head support of FIG. 1.

FIG. 3 is a side view of a pedestal of the head support of FIG. 1.

FIG. 4 is a bottom view of the pedestal of FIG. 3.

FIG. 5 is a cutaway view of the pedestal of FIG. 3.

FIG. 6 is a side view of a shaft of the head support of FIG. 1.

FIG. 7 is a side view of the shaft of FIG. 6.

FIG. 8 is a top view of the shaft of FIG. 6.

FIG. 9 is a top view of a chest base of the head support of FIG. 1.

FIG. 10 is a top view of a height adjuster of the head support of FIG. 1.

FIG. 11 is a cutaway view of the height adjuster of FIG. 10.

FIG. 12 is a perspective view of the head support of FIG. 1.

FIG. 13 is a schematic view of the head support of FIG. 1 in use.

FIG. 14 is an exploded view of a head support in accord with one embodiment of the current disclosure.

FIG. 15 is a side view of the head support of FIG. 14 in use.

FIG. 16 is an exploded view of a head support in accord with one embodiment of the current disclosure.

FIG. 17 is a side view of the head support of FIG. 16 folded into a flattened arrangement.

FIG. 18 is a side view of the head support of FIG. 16 in use.

### DETAILED DESCRIPTION

Disclosed is a head support. The support includes a compact height and angle adjustable column that can be telescopically adjusted to fit comfortably between a user's chin and chest. The support holds the user's head in a supported position during resting.

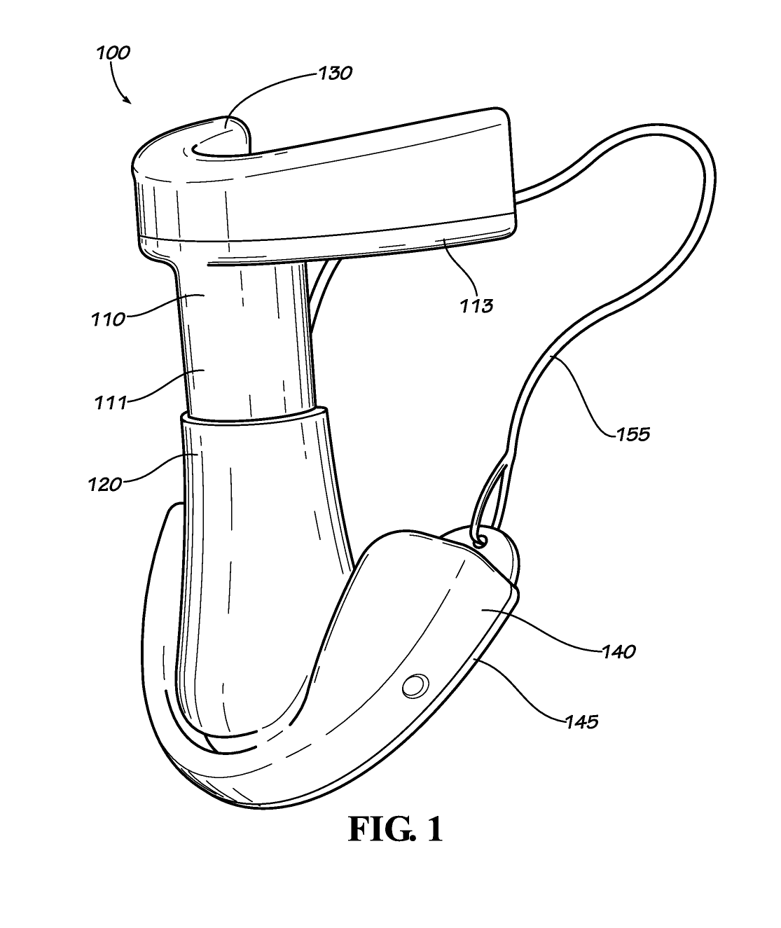

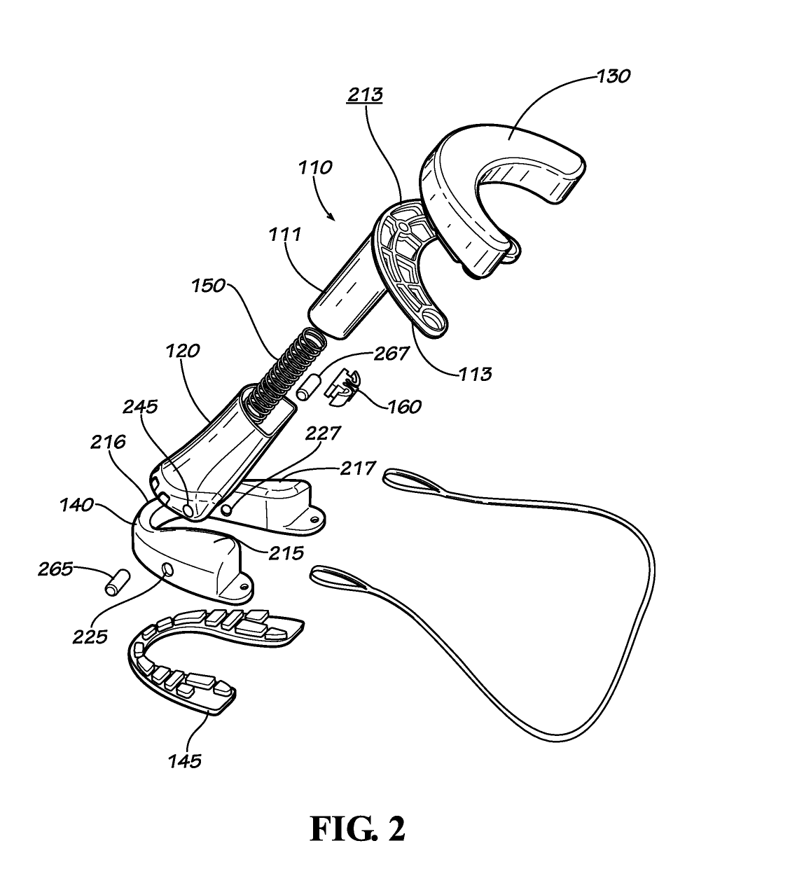

As seen in FIG. 1, head support 100 includes a pedestal 110, a shaft 120, a rest 130, a chest base 140, a biasing element 150 (seen in FIG. 2), and a height adjuster 160 (seen in FIG. 2). In the current embodiment, the pedestal 110 includes a column 111 and a platform 113. In some embodiments, the pedestal 110 will include only the column 111, wherein the platform 113 may be omitted or may be a portion of the rest 130. In the current embodiment, the rest 130 is a pad. In the current embodiment, a foot 145 is connected to the chest base 140. The foot 145 provides a soft and/or gripping surface to increase comfort and/or to provide frictional grip on a user's clothing or chest to remain securely in position on user's chest. In various embodiments, the foot 145 may be integrated with the chest base 140. In the current embodiment, a lanyard 155 is connected to the chest base 140.

As seen in FIG. 2, the biasing element 150 is disposed between the pedestal 110 and the shaft 120 inside the hollow assembly formed by the shaft 120 and the column 111 of the pedestal 110. The chest base 140 in the current embodiment is U-shaped and includes two flaring portions 215,217 connected by a connecting portion 216. A pin bore 225,227 is defined in each flaring portion 215,217. Also seen in the shaft 120 is a pin recess 245. Another pin recess 247 (not shown) is located opposite the pin recess 245.

Pivot pins 265,267 provide the axis of rotation of the shaft 120 with respect to the chest base 140. The pivot pins 265,267 also provide a frictional interference fit so that the shaft 120 can be rotated but may be substantially fixed in an orientation with respect to the chest base 140 without any switches, stops, or extraneous moving parts. In other embodiments, another mechanism may provide a mechanical stop, the motion may be biased with a biasing element, or the chest base 140 may be integrated with the shaft 120 or otherwise set in a fixed angle with respect to the shaft 120. In some embodiments, detents may be included to releasably align the chest base 140 in orientation with the shaft 120. In the current embodiment, the pivot pins 265,267 are cylindrical pins, although they may be various shapes in various embodiments.

In the current embodiment, the pivot pins 265,267 are press-fit into the pin bores 225,227, passing through the pin bores 225,227 and into the pin recesses 245,247. The pin recesses 245,247 of the current embodiment are of a depth that is less than the length of the pivot pins 265,267 so that the pivot pins 265,267 protrude from the sides of the shaft 120. The protrusion keeps the pivot pins 265,267 inside the pin bores 225,227 for frictional rotation.

As can be seen, the platform 113 of the pedestal 110 has a contact surface 213 that includes multiple mating recesses. The contact surface 213 includes a plurality of mating recesses in the current embodiment, although other configurations are contemplated by this disclosure, including a flat surface or any number or shape of mating recesses. In some embodiments—such as when a foam material is used for the rest 130—mating recesses are desirable because they provide added surface contact for gluing with the rest 130. In other embodiments—when a gel urethane material is used, for example—a flat profile is desirable because mating recesses tend to cause inconsistencies in the thickness of the gel urethane unless the gel urethane is shaped to accommodate the mating recesses. The mating recesses in the current embodiment mate in shape with the rest 130 so that the rest 130 can be easily affixed to the platform 113. The rest 130 in the current embodiment is affixed to the contact surface 213 by gluing. In other embodiments, the rest 130 may be integral with the platform 113 or may be affixed to the contact surface 213 by other fasteners, including screws, key fits, mechanical interference fits, Velcro, and nails, among others. In the current embodiment, the rest 130 is made of gel urethane material or foam material, but may be many types of materials, including plastic, urethane, polymer, polyethylene, resin, elastomer, elastomeric foam, rubberized foam, other types of foam, rubber, wood, metal, cloth, composite, feather, leather, cotton, beads/pellets/foam beads, and nylon, among others. The rest 130 is designed for the user's head to sit upon as a support, particularly as a contact for the user's chin. As such, any material suitable for the purpose may be used to provide a soft and/or deformable surface to increase comfort and to provide direct support to the underside of the user's chin or simply to provide support, as desired.

The rest 130 of the current embodiment is a crescent shape. The crescent shape supports the user's head at multiple points to prevent discomfort. Additionally, the crescent shape allows the user to put pressure on the rest 130 from multiple orientations, thereby reducing the chance of slippage with the user's chin. In the current embodiment, end portions of the rest 130 are thicker than a central portion. However, this is not necessary, and the rest 130 may have a consistent thickness throughout the crescent shape. Additionally, the rest 130 may be in various thicknesses as desired.

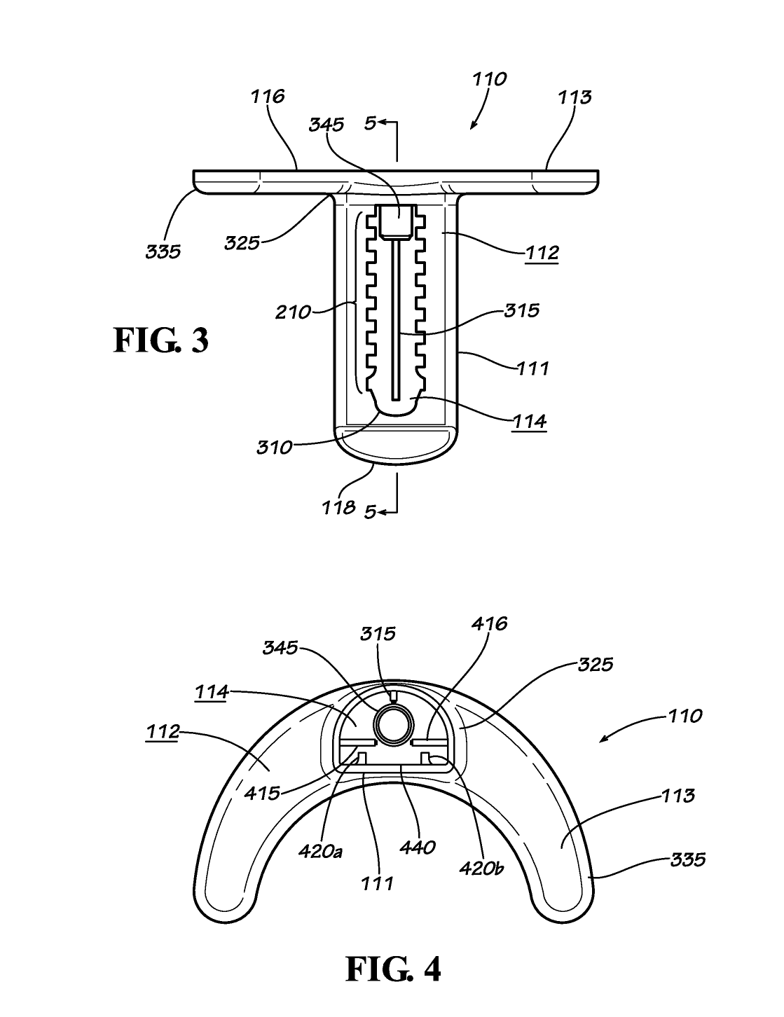

FIG. 3 is an inner side view of the pedestal 110. Height adjustment teeth 210 can be seen on pedestal 110. The pedestal 110 includes an outer surface 112, an inner surface 114, a top end 116, and a bottom end 118. The height adjustment teeth 210 are defined in the walls of a height adjustment recess 310. A spring rib 315 is seen inside the column 111. As can be seen from the view, the bottom end 118 of the pedestal 110 is angled with respect to the top end 116.

A corner radius 325 is seen on the border between the column 111 and the platform 113. Also, an edge radius 335 is seen on the bottom of the platform 113. A spring seat 345 is seen by viewing through the height adjustment recess 310 into an internal cavity 440 (seen in FIG. 4) of the pedestal 110. In the current embodiment, the spring seat 345 is a cylindrical boss protruding from the inner surface 114.

As seen in the bottom view of FIG. 4, spring ribs 415 and 416 are also located inside the internal cavity 440. Structural reinforcements 420a,b are located along the height adjustment recess 310. As seen in the bottom view of FIG. 4, the platform 113 is formed in a crescent shape in the current embodiment. The crescent shape of the platform 113 matches the rest 130. Other embodiments may include other shapes for the platform 113. The internal cavity 440 is also seen defined in the pedestal 110 in the current view.

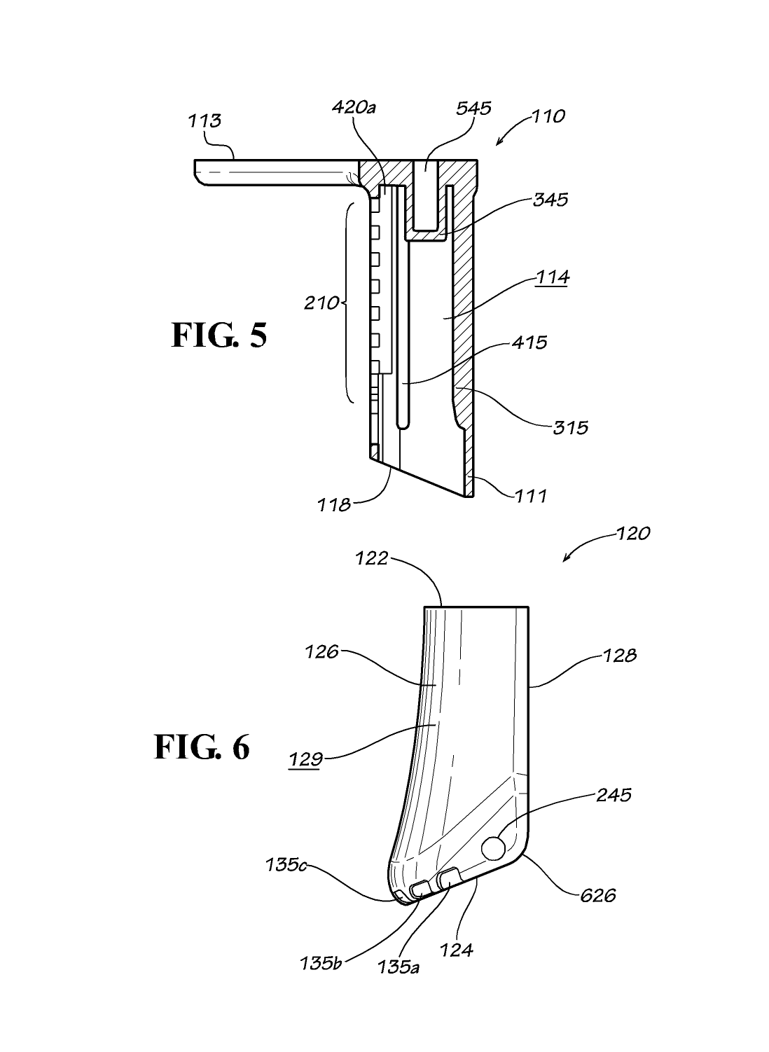

FIG. 5 shows a cutaway view of the pedestal 110. As seen in FIG. 5, the spring seat 345 is hollow and defines a recess 545. The slant of the bottom end 118 can also be seen in the cutaway view of FIG. 5.

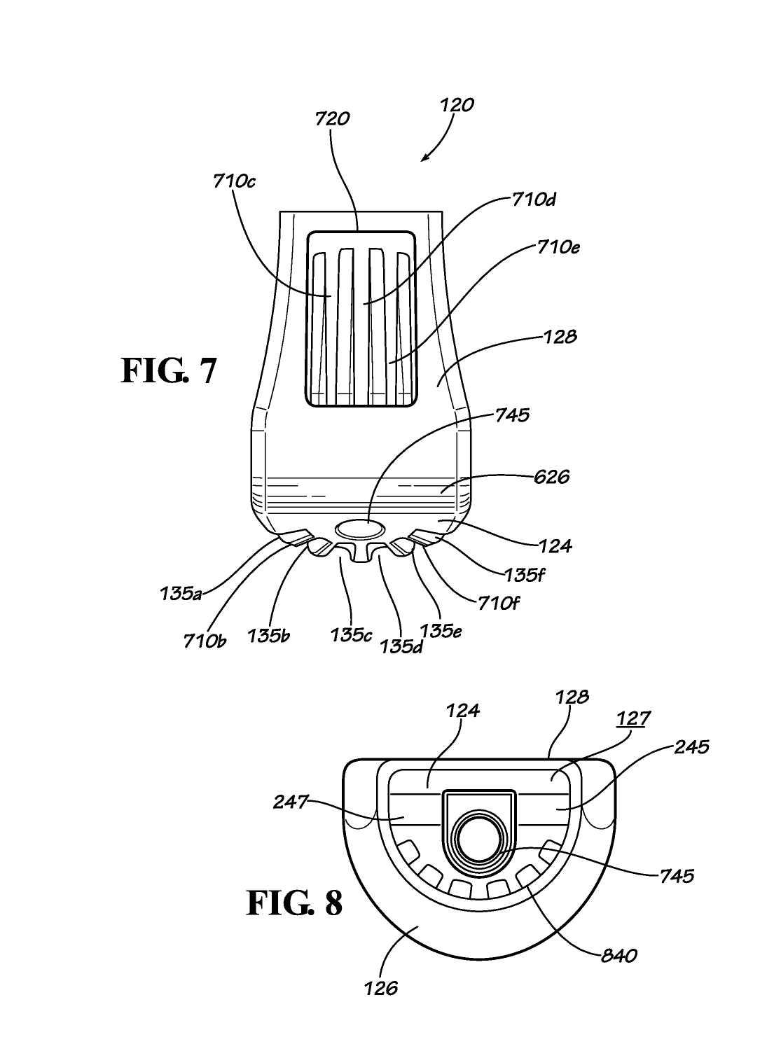

The shaft 120 is seen in side view in FIG. 6. The shaft 120 includes outer surface 129, an inner surface 127 (seen in FIG. 8), a top end 122, a bottom end 124, a first shaft side 126, and a second shaft side 128. The shaft 120 defines six vent holes 135a,b,c,d,e,f (d,e,f, seen in FIG. 7). The vent holes 135a,b,c,d,e,f are defined by ribs 710 (shown in FIG. 7) that extend into the interior of the shaft 120. The ribs 710 provide a mechanical guide for the movement of the pedestal 110 within the shaft 120. The tapered profile of the shaft 120 can be seen in side view as the top end 122 is smaller in width than the bottom end 124. The shaft 120 need not be a specific shape or profile. For example, in various embodiments, the shaft 120 could be formed as an “open” C-channel. The chest base 140 may also be formed integrally to the shaft 120 in various embodiments. The bottom end 124 is angled with respect to the top end 122. A radius 626 provides a smooth transition from the second shaft side 128 to the bottom end 124. The pin recess 245 can be seen in the side view.

FIG. 7 shows a side view of the shaft 120 as looking at the second shaft side 128. As stated previously, the vent holes 135a,b,c,d,e,f are defined by ribs 710b,c,d,e,f (710a,g not seen in the current view). The ribs 710a,b,c,d,e,f,g are sized to accept the column 111 within the shaft 120 and align the pedestal 110 with respect to the shaft 120. Several of the ribs 710c,d,e are seen in an internal cavity 840 (seen in FIG. 8) viewing through a height adjustment recess 720. The internal cavity 840 in the current embodiment is larger than the outer width dimension of the column 111 so that the column 111 fits within the internal cavity 840 in assembly. The height adjustment recess 720 is defined in the second shaft side 128. A spring seat 745 is seen in the bottom end 124. The spring seat 745 is a cylinder formed integrally with the bottom end 124.

Turning to FIG. 8, the spring seat 745 is seen protruding from the bottom end 124. The internal cavity 840 is also seen defined by the shaft 120. The spring seat 745 provides a rim against which the biasing element 150 (a helical spring in the current embodiment) may be positioned. It can also be seen that the pin recesses 245,247 are not entirely enclosed and meet the internal cavity 840 at the bottom end 124.

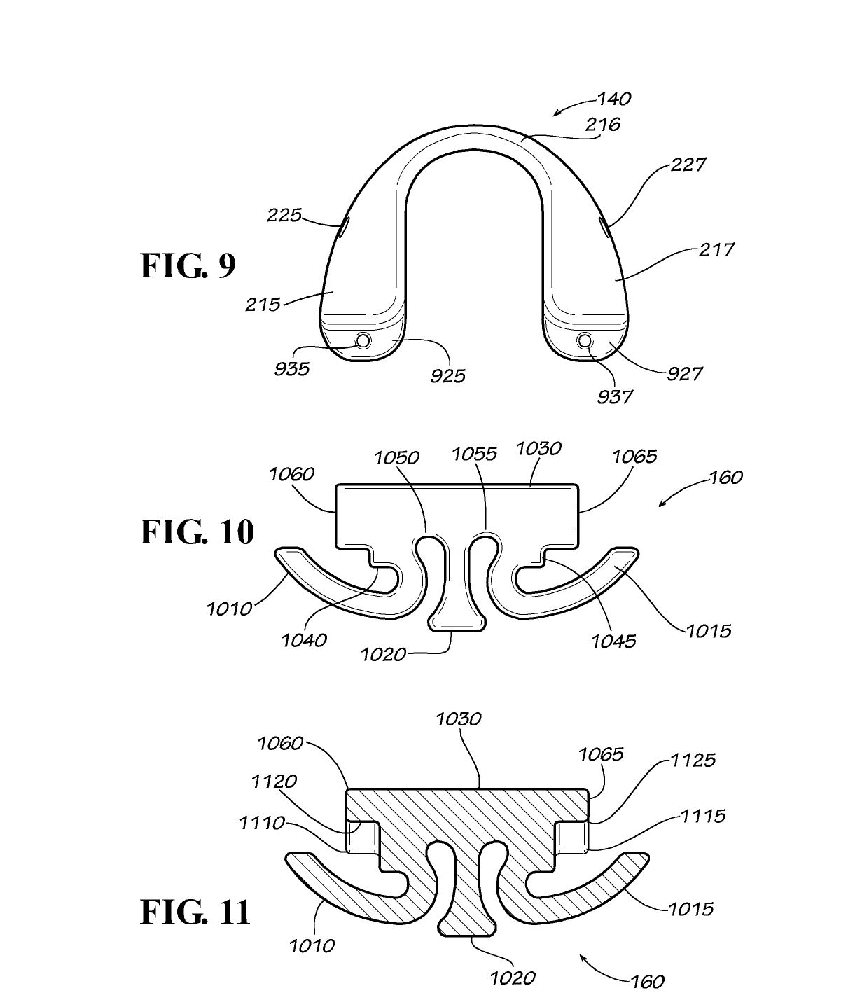

The chest base 140 is seen in FIG. 9. The flaring portions 215,217 include lanyard tabs 925,927 for attachment of the lanyard 155. Lanyard attachment bores 935,937 are seen defined in the lanyard tabs 925,927. Ends of the lanyard 155 are inserted into the lanyard attachment bores 935,937.

In various embodiments, the lanyard 155 may include various features. As shown, the lanyard 155 is a simple strap. However, the lanyard 155 may also include a length adjuster. In one embodiment, the length adjuster is a spring-loaded stopper. In other embodiments, various length adjusters may be used including clamps, clips, ties, knots, and others. Additionally, the lanyard 155 may include a release mechanism. In various embodiments, the release mechanism may be one of snap fasteners, magnets, spring buckles, ratchet buckles, plastic buckles, screw attachments, and others. For example, in one embodiment, a plastic buckle release mechanism is included to provide a quick release of the lanyard 155 from the chest base 140 when desired.

As seen in FIGS. 10 and 11, the height adjuster 160 of the current embodiment is a spring-loaded push-button. The height adjuster 160 includes two wings 1010,1015 that are leaf springs formed in a curve. A button 1020 is formed between the wings 1010,1015. A base portion 1030 serves as the anchor from which the wings 1010,1015 and the button 1020 connect. Stop shoulders 1040,1045 are formed between the wings 1010,1015 and the base portion 1030. Recesses 1050,1055 are also formed between the wings 1010,1015 and the button 1020. Additionally, interface portions 1060,1065 are formed at the sides of base portion 1030.

As can be seen with reference to FIG. 11, each interface portion 1060,1065 includes a step shoulder 1110,1115 and a rest shoulder 1120,1125. The rest shoulders 1120,1125 are designed to seat with the teeth 210 at rest, whereas the step shoulders 1110,1115 are designed to provide a mechanical stop when at rest. The step shoulders 1110,1115 are dimensioned so that the movement of the height adjuster 160 by depression of the button 1020 will cause the wings 1010,1015 to flex and allow the step shoulders 1110,1115 to pass under the teeth 210.

Although height adjuster 160 and teeth 210 are seen in the current embodiment, the height adjuster 160 should not be considered limiting on the disclosure. In various embodiments, the height adjuster 160 may be a draw string which retracts against spring expansion bias, screw adjustment, a cam lock, a cinch ring (similar to the telescopic leg adjustment on a tripod), or using the stated elements to create fixed height adjustment that eliminates the biasing element 150, among others. In other embodiments, the biasing element 150 may be a hydraulic resistance member or a “shock-absorber,” for which the height may be adjusted by hydraulic resistance. In other embodiments, the biasing element 150 may be spring loaded-along a track, such as a ball bearing on a bearing track. In such cases, the height may be adjusted by limiting the travel of the ball bearing along the bearing track.

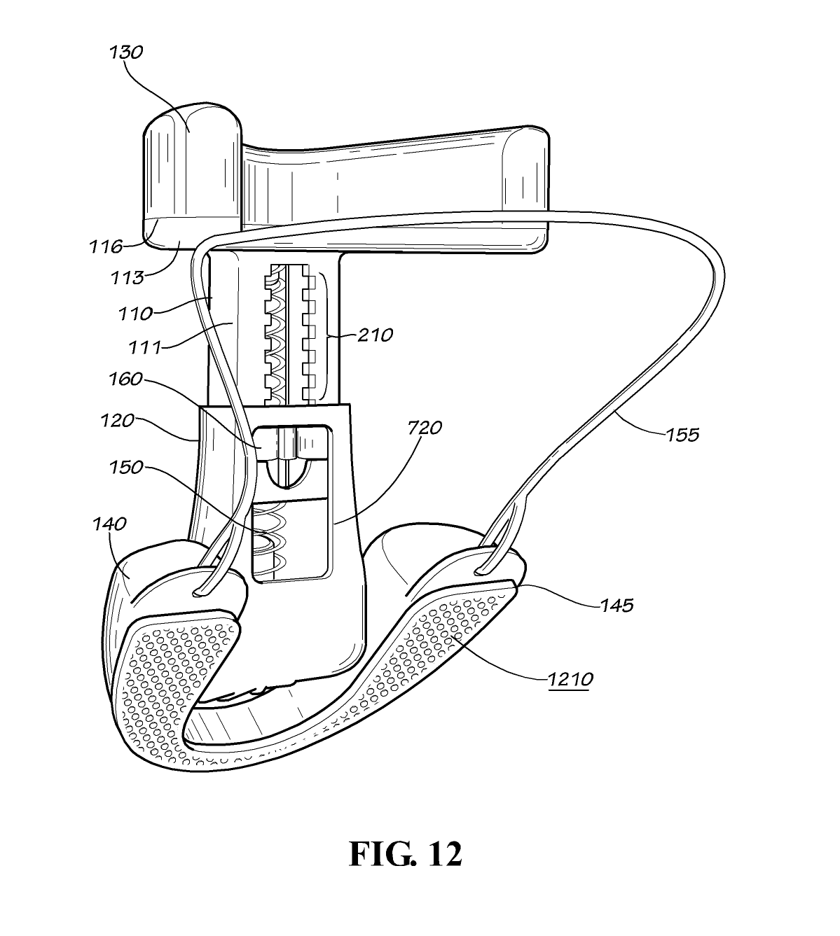

As can be seen in FIG. 12 (and with additional reference to FIG. 2 for clarity), the rest 130 is connected to the top end 116 of the pedestal 110 by gluing. The chest base 140 is connected to the shaft 120 through pivot pins 265,267. The biasing element 150 is inserted between the pedestal 110 and the shaft 120 and biases the pedestal 110 and rest 130 against the shaft 120 and chest base 140. The height adjuster 160 allows the user to adjustably change the distance between the rest 130 and the chest base 140. The biasing element 150 is a helical spring in the current embodiment but may be various types of bias in various embodiments, including leaf springs, foam, plastic springs, rubber, magnets, and gravitational biasing, among others. The biasing element 150 is internal to both the pedestal 110 and the shaft 120 and biases the pedestal 110 against the shaft 120. Because the shaft 120 is connected to the chest base 140 and the pedestal 110 is connected to the rest 130, the biasing element 150 provides bias of the chest base 140 against the rest 130 as well. As such, when the user places the chest base 140 on his chest with the foot 145 in contact with the user's chest, the rest 130 receives a bias from the biasing element 150 imparted to the user's chin, thereby providing support.

The height adjuster 160 is seen inserted between the shaft 120 and the pedestal 110. The rest shoulders 1120,1125 of the height adjuster 160 fit into height adjustment teeth 210 to prevent movement of the pedestal 110 with respect to the shaft 120 in at least one direction. The height adjuster 160 is locked into the teeth 210 of the pedestal 110. As such, it is able to move with the pedestal 110. Until desired, it cannot move with respect to the pedestal 110. In the current embodiment, the height adjuster 160 stops against a top end of the height adjustment recess 720. This occurs because the biasing element 150 imparts a separating bias on the pedestal 110 and the shaft 120. As such, the height adjuster 160 provides the mechanical stop to prevent the pedestal 110 from separating from the shaft 120.

The height adjuster 160 is in contact with the height adjustment recess 720 on only one side. As such, the pedestal 110 may move with respect to the shaft 120 in the direction that is not in contact with the height adjustment recess 720. If the pedestal 110 is depressed enough, the column 111 will retract far enough into the internal cavity 840 of the shaft 120 that the height adjuster 160 will come into contact with the other side of the height adjustment recess 720, providing a mechanical limit on the retraction of the head support 100. Additionally, the length of the column 111 may provide a mechanical limitation on the retraction into the shaft 120 as the bottom end 118 of the pedestal 110 may come into contact with the bottom end 124 of the shaft 120.

The lanyard 155 is shown attached to the chest base. However, the lanyard 155 is optional and may be included for ease of use in some embodiments and omitted in others. As can be seen in the view of FIG. 12, the bottom of the foot 145 includes a textured surface 1210 for gripping, as described above. The foot 145 may be made out of rubber or other various materials in various embodiments, including gel plastic, urethane, polymer, polyethylene, resin, elastomer, elastomeric foam, rubberized foam, other types of foam, rubber, wood, metal, cloth, composite, feather, leather, cotton, and nylon, among others

With reference to FIGS. 10-12, adjustment of the maximum height is allowed when the button 1020 is depressed. Depression of the button 1020 causes the base portion 1030 to move toward the internal cavity 440. However, the wings 1010,1015 are prevented from moving toward the internal cavity 440 because they are mechanically stopped against the column 111, as the wings 1010,1015 are dimensioned wider than the height adjustment recess 310. As such, the leaf spring effect of the wings 1010,1015 occurs, and the wings 1010,1015 flex, allowing the base portion 1030 to move toward the internal cavity 440 enough to allow the step shoulders 1110,1115 to clear the teeth 210. When the step shoulders 1110,1115 are no longer in interference with the teeth 210, the height adjuster 160 may move in the height adjustment recess 310 and allow the user to set a new maximum height.

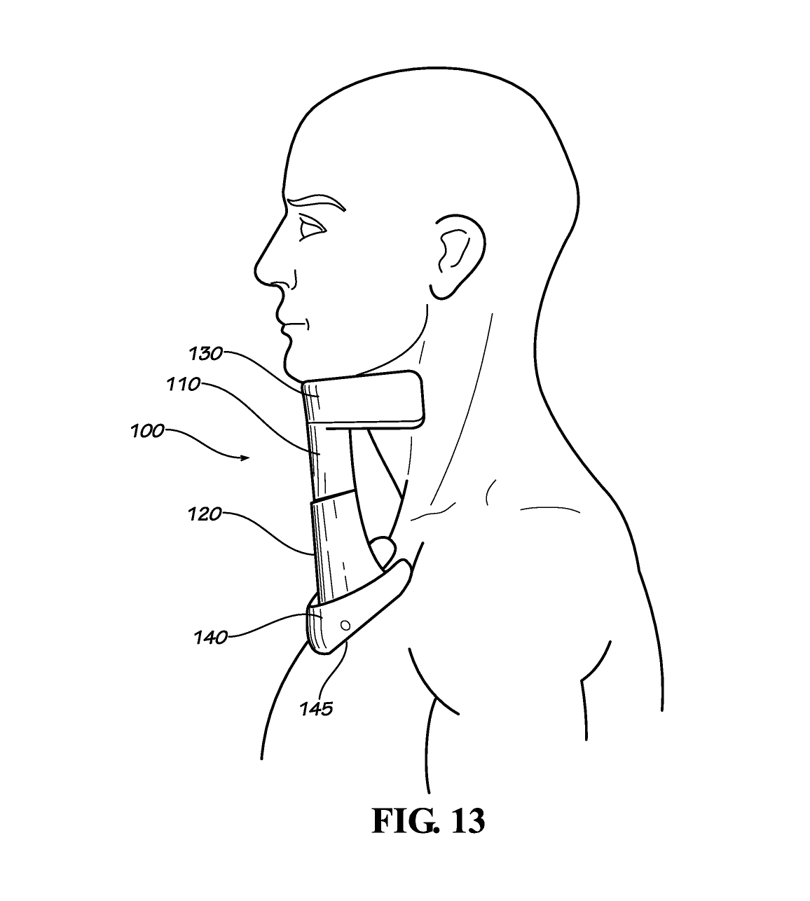

Use of the head support 100 is shown in FIG. 13. The user sets the maximum height of the head support 100 by adjusting the height adjuster 160 in the teeth 210. The user places the head support 100 between his or her chest and chin so that the foot 145 contacts the user's chest and the rest 130 contacts the user's chin. The weight of the user's head will most likely cause the pedestal 110 to retract inside the shaft 120 to some degree. However, the biasing element 150 resists the weight of the user's head and provides comfortable support. The rest 130, being of suitable shape and/or material to support the user's head comfortably, prevents force from being applied in one spot of the user's chin and aids in providing comfort to the user. Steps as disclosed herein may be modified or have their orders changed based on the user's preferred method of use.

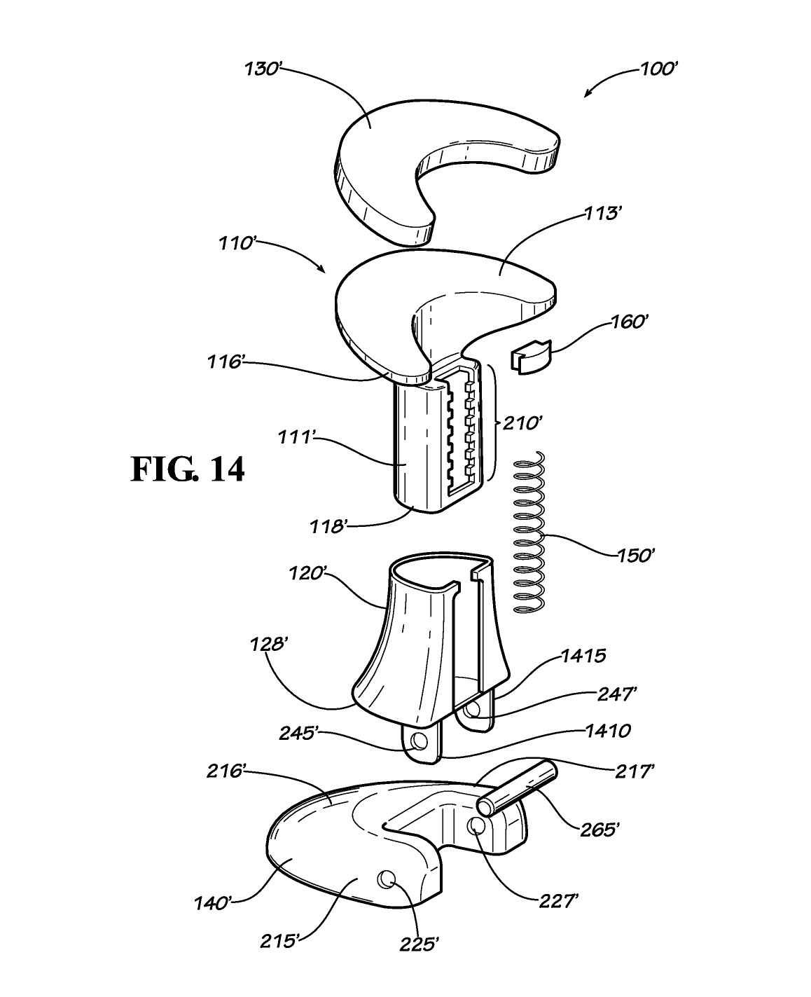

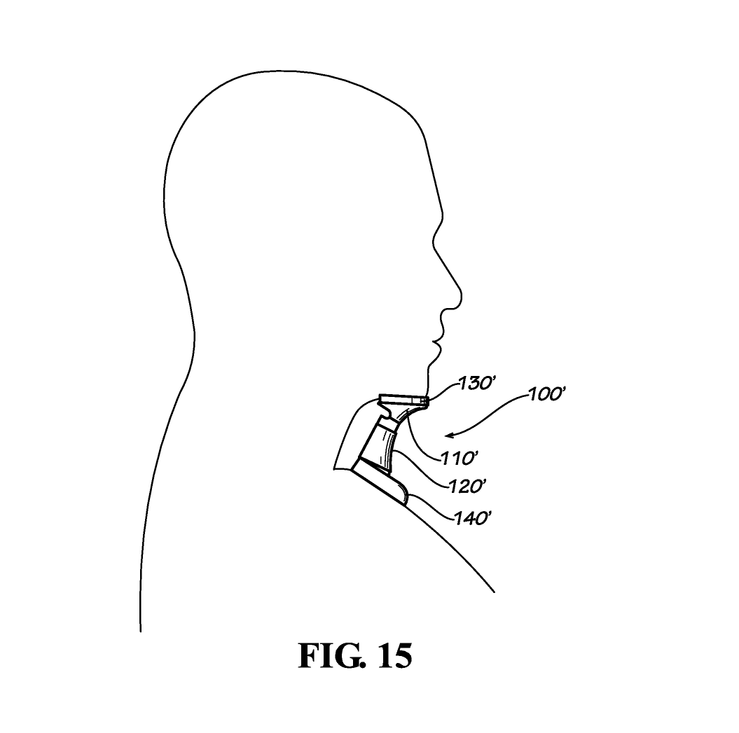

FIG. 14 is an exploded view of another embodiment of a head support 100′. In this embodiment, a rest 130′ is somewhat flatter in shape than the rest 130. A pedestal 110′ includes a column 111′ and a platform 113′. The platform 113′ has a relatively flat shape, wherein the platform 113 included mating recesses. Height adjustment teeth 210′ are formed in the column 111′. The pedestal 110′ includes a bottom end 118′ that is not angled with respect to a top end 116′ of the pedestal 110′. A biasing element 150′ is shown and is designed to fit between the pedestal 110′ and a shaft 120′. Pin recesses 245′,247′ are located in tabs 1410,1415 extended from a bottom end 128′ of the shaft 120′. A chest base 140′ includes flaring portions 215′,217′ and a connecting portion 216′. Pin bores 225′,227′ accommodate one pivot pin 265′ inserted through the pin recesses 245′,247′ as a pivot for the head support 100′. The head support 100′ can be seen in use in FIG. 15.

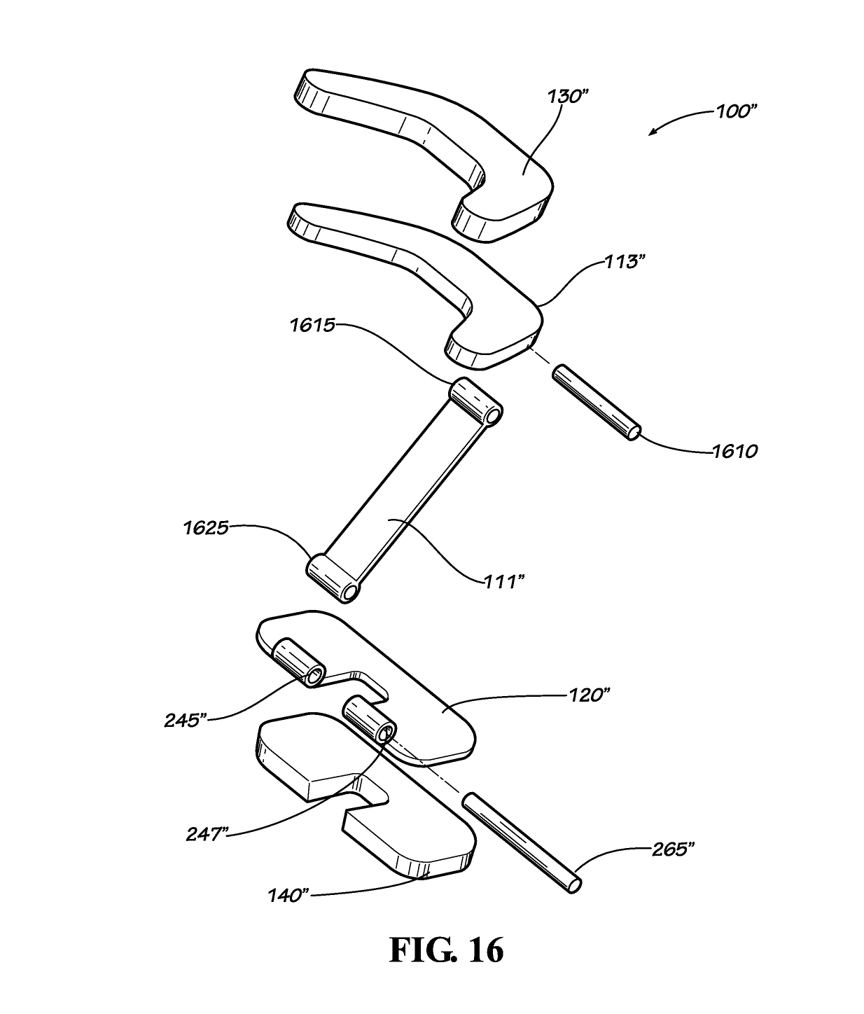

Another embodiment of a head support 100″ is seen in FIG. 16. A rest 130″ is connected to a platform 113″. The platform 113″ is connected to a column 111″ by a pivot pin 1610, which is extended through a pivot bore 1615 in the column 111″ and two pivot bores (not shown) on an underside of the platform 113″. The column 111″ is then connected to an upper chest base 120″ by a pivot pin 265″ extending through pin recesses 245″,247″ and through pivot bore 1625. The upper chest base 120″ is connected to a lower chest base 140″ that acts as a foot in the current embodiment. In the current embodiment, the column 111″ is designed as a leaf spring so that pressure on the rest 130″ is met with some resistance but is not rigid. In this way, the column 111″ functions as a biasing element to bias the platform 113″ against the upper chest base 120″.

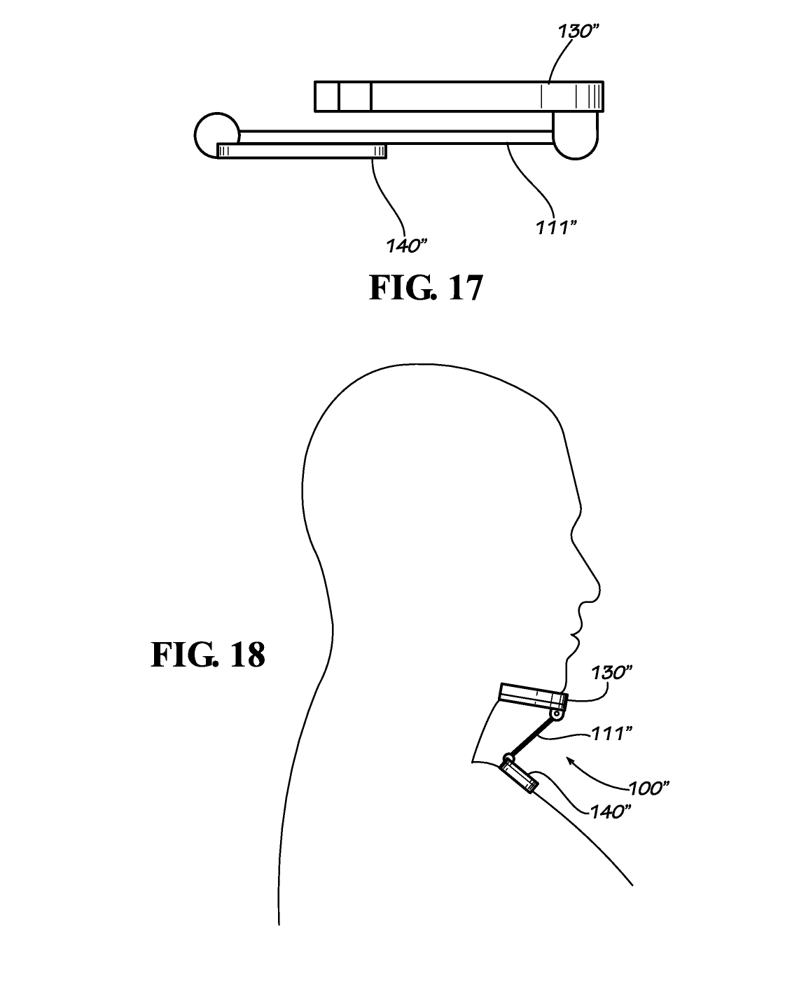

The head support 100″ is designed to fold in a Z-shape as seen in FIG. 17. The Z-shape allows the head support 100″ to be compacted and easily transported. In various embodiments, the column 111″ may not act as a leaf spring. In various embodiments, the pivot pins 265″,1610 may be biased by rotational springs. The head support 100″ can be seen in use in FIG. 18.

Where materials are chosen for the elements of this assembly, similar material choices may also be used and would be obvious to one in the art, including corrugated cardboard or paper, linerboard, polymer, plastic, metal, alloy, wood, mesh, laminate, reinforced woven or nonwoven fabric, cellulose, composite, nylon, rubber, resin, elastomer, urethane, polymers, leather, cotton, and combinations or mixtures of the foregoing, among others.

One should note that conditional language, such as, among others, “can,” “could,” “might,” or “may,” unless specifically stated otherwise, or otherwise understood within the context as used, is generally intended to convey that certain embodiments include, while alternative embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

1. A support comprising:
a column having an outer surface, an inner surface, a top end, and a bottom end;
a shaft having an outer surface, an inner surface, a top end, and a bottom end;
a rest connected to the top end of the column;
a chest base connected to the bottom end of the shaft;
a biasing element biasing at least one of the rest and the column against at least one of the shaft and the chest base; and
a height adjuster operably connected to at least one of the shaft and the column.

2. The support of claim 1 further comprising a lanyard connected to the support.

3. The support of claim 1 further comprising a foot connected to the chest base.

4. The support of claim 1, wherein the biasing element is a spring.

5. The support of claim 1, wherein the biasing element is disposed inside at least one of the column and the shaft.

6. The support of claim 1, wherein the connection between the chest base and the bottom end of the shaft is a rotatable connection.

7. The support of claim 1, wherein the rest is made of at least one of gel, foam, and rubber.

8. A support comprising:
a platform;
a chest base; and
a biasing element biasing the platform against the chest base,
wherein the chest base is rotatable with respect to the platform.

9. The support of claim 8 further comprising a lanyard connected to the support.

10. The support of claim 8 further comprising a foot connected to the chest base.

11. The support of claim 8 further comprising a rest connected to the platform.

12. The support of claim 8, wherein the biasing element is a spring.

13. The support of claim 8, wherein the biasing element is disposed inside at least one of the column and the shaft.

14. The support of claim 8, wherein the connection between the chest base and the bottom end of the shaft is a rotatable connection.

15. The support of claim 8, wherein the rest is made of at least one of gel, foam, and rubber.

16. A method of using a support comprising:
positioning a support in contact with a chest of a user and a chin of the user such that the chest is braced against a chest base and the chin is in contact with a rest;
applying pressure from the chin to the rest
activating a height adjuster;
setting a height threshold; and
deactivating the height adjuster.

17. The method of claim 16 further comprising:
placing a lanyard around the neck of a user, and
adjusting a length of the lanyard.
